(19) United States
(12) Patent Application Publication
(10) Pub. No.: US 2025/0154750 A1
(43) Pub. Date: May 15, 2025

(54) FAUCET

(71) Applicant: Wei-Cheng Tseng, Taichung (TW)

(72) Inventor: Wei-Cheng Tseng, Taichung (TW)

(21) Appl. No.: 18/505,124

(22) Filed: Nov. 9, 2023

(51) Int. Cl. E03C 1/04; C02F 1/461; E03C 1/02

(52) U.S. Cl. CPC E03C 1/0403; C02F 1/4618; C02F 2001/4619; C02F 2201/005; C02F 2201/46145; C02F 2307/06; E03C 2001/026; E03C 2201/40

(57) ABSTRACT

A faucet includes for use with a water ionizer and a tap water source, comprising a housing, a mechanism disposed in the housing, a fastening member secured to an upper portion of the housing above the mechanism, a spout extending from the mechanism through the fastening member, and a selection switch disposed on an outer surface of the housing for activating a flow from the water ionizer or the tap water source wherein the mechanism is connected to a first inlet line connected to the tap water source, a second inlet line connected to the water ionizer, and a guide line connected to the water ionizer; an electromagnetic valve disposed on the mechanism, electrically connected to the selection switch, and controlled by the selection switch wherein the electromagnetic valve includes a valve member.

### BACKGROUND OF THE INVENTION

### 1. Field of the Invention

The invention relates to faucet and more particularly to a faucet having water flowing from a water ionizer or tap water source.

### 2. Description of Related Art

In recent years, due to the rapid development of industry, air, land and water sources have been polluted. Thus, when people pay attention to health and hygiene, they will buy a water filter for filtering tap water. In order to promote health, reverse osmosis water, electrolyzed water, calcium ion water, hydrogen water, etc. have recently been introduced to emphasize their different beneficial effects on the health.

There is water ionizer commercially available. The water ionizer can electrolyze water and produce alkaline water in which hydrogen molecules are dissolved. Alkaline water has attracted attention because it is free of active oxygen. A water ionizer provided under the countertop has a water conduit connected to a tap water source or a water filter. The water ionizer is connected to a faucet provided on the countertop through a water conduit. Because the water ionizer may generate alkaline water, when the water is released, acidic water will be discharged simultaneously. The acidic water has bactericidal effect so that people may use it for washing hands, washing fruits and vegetables, or washing tableware.

However, a faucet connected to a water ionizer can only be used to flow alkaline water rather than flow water from a tap water source at the same time. Thus, separate faucets with different water flowing modes need to be installed on the countertop. This not only takes up space but also damage the overall layout of the countertop. The water ionizer is directly connected to the sink drain and it may cause inconvenience to the user when using the alkaline water. While some manufacturers connect the inlet line of the water source to the faucet, it is not a good solution. Further, it has complicated components, it increases the manufacturing difficulty and cost, it increases the volume of the faucet, and greatly reduce its practicality. In other words, the conventional faucet connected to the water ionizer is disadvantageous.

Thus, the need for improvement still exists.

### SUMMARY OF THE INVENTION

It is therefore one object of the invention to provide a faucet comprising

The above and other objects, features and advantages of the invention will become apparent from the following detailed description taken with the accompanying drawings.

### BRIEF DESCRIPTION OF THE DRAWINGS

FIG. 1 is a perspective view of a faucet according to a first preferred embodiment of the invention;

FIG. 2 is a longitudinal sectional view of the faucet;

FIG. 3 is an exploded view of the faucet components shown in an upper part of FIG. 1;

FIG. 4 is an exploded view of the faucet components shown in an upper part of FIG. 3;

FIG. 4A is an exploded view of the second two-port valve;

FIG. 5 is a partially broken away view of the faucet components shown in an intermediate part of FIG. 4;

FIG. 6 is a view similar to FIG. 2 showing the faucet for use with a tap water source;

FIG. 7 is a view similar to FIG. 2 showing the faucet for use with a water ionizer;

FIG. 8 is a longitudinal sectional view of a faucet according to a second preferred embodiment of the invention;

FIG. 9 is a longitudinal sectional view of a faucet according to a third preferred embodiment of the invention; and

FIG. 10 is a longitudinal sectional view of a faucet according to a fourth preferred embodiment of the invention.

### DETAILED DESCRIPTION OF THE INVENTION

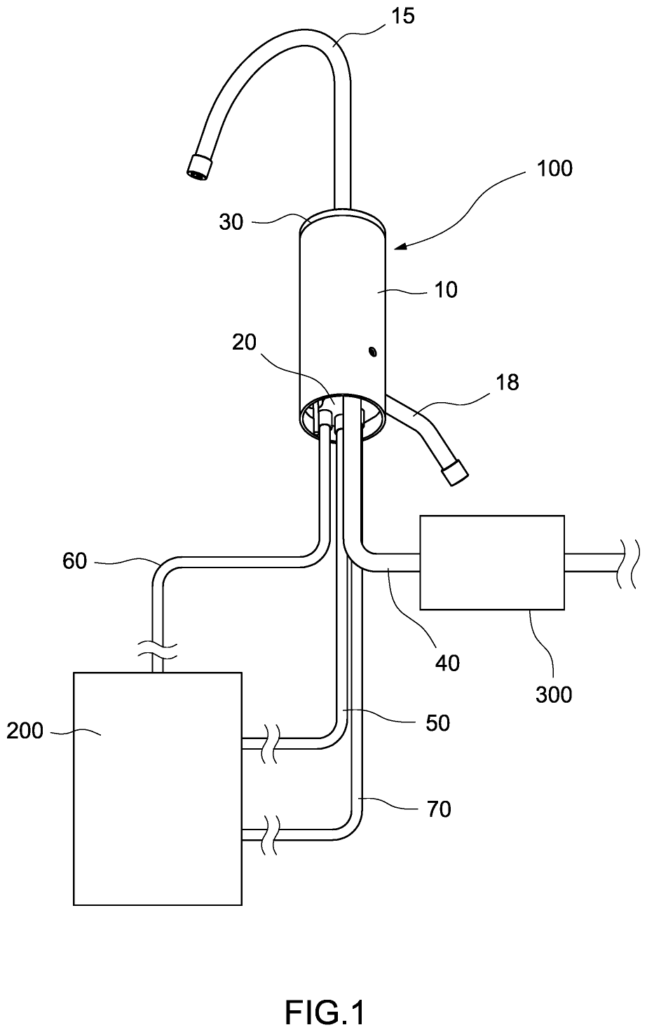

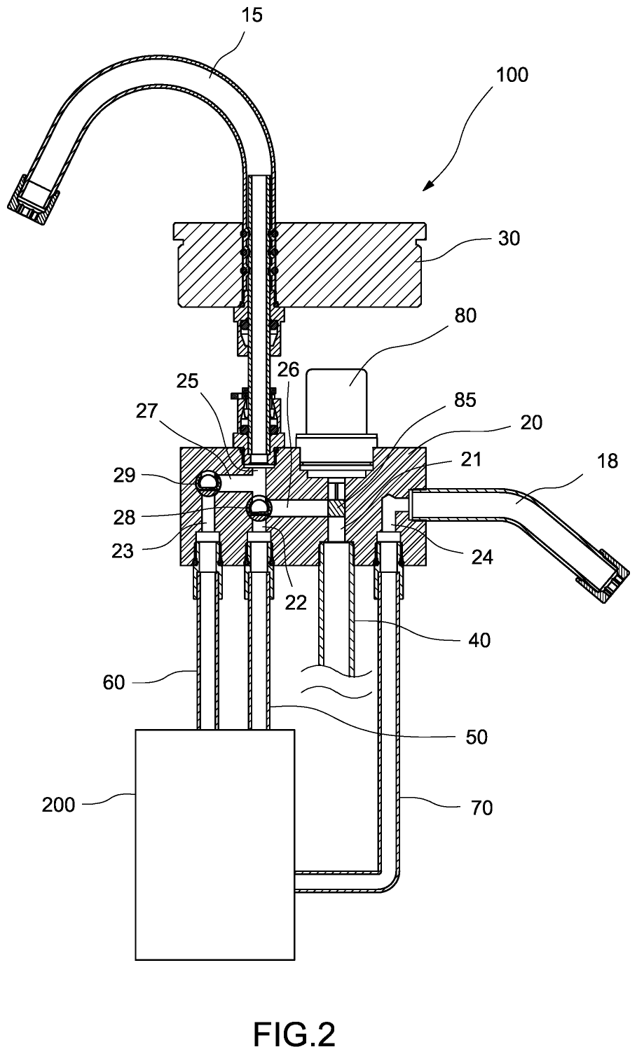

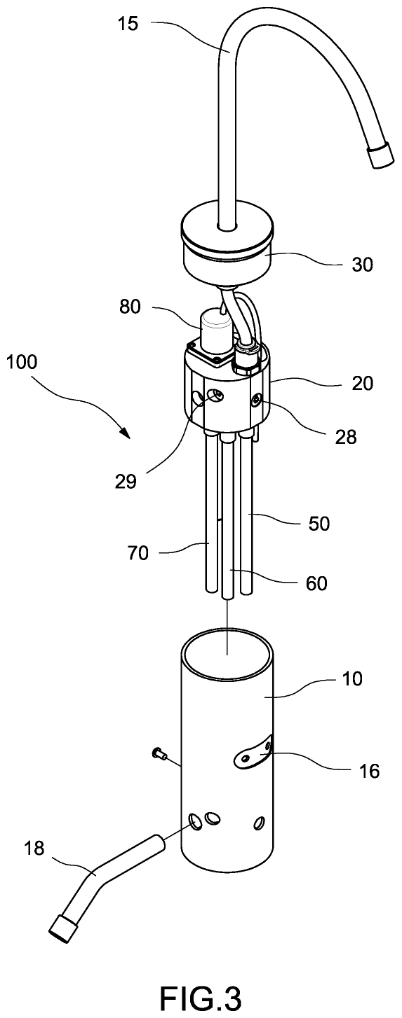

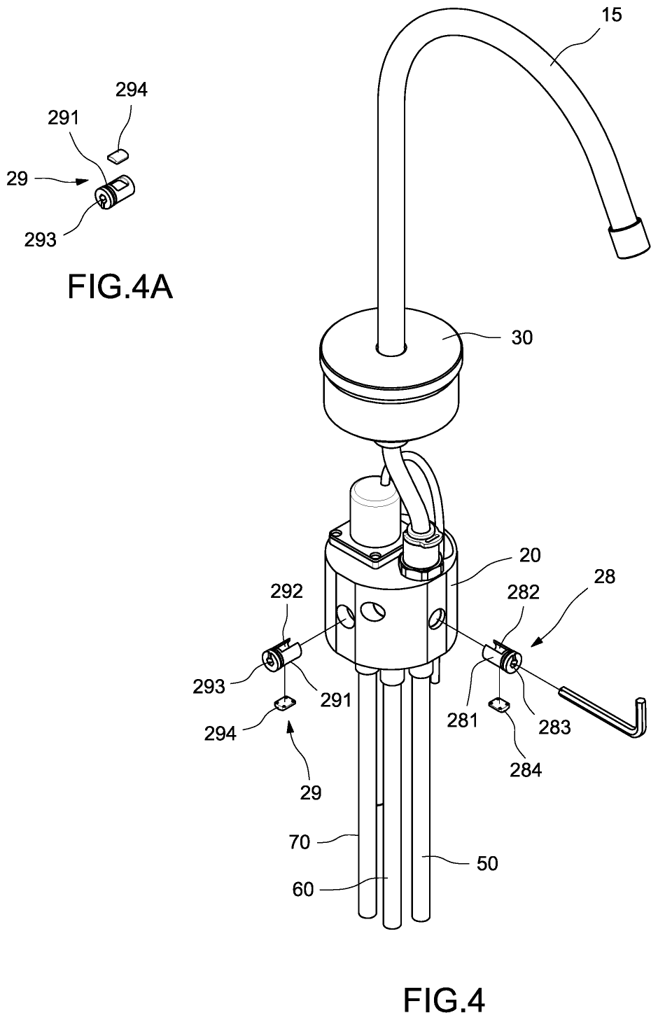

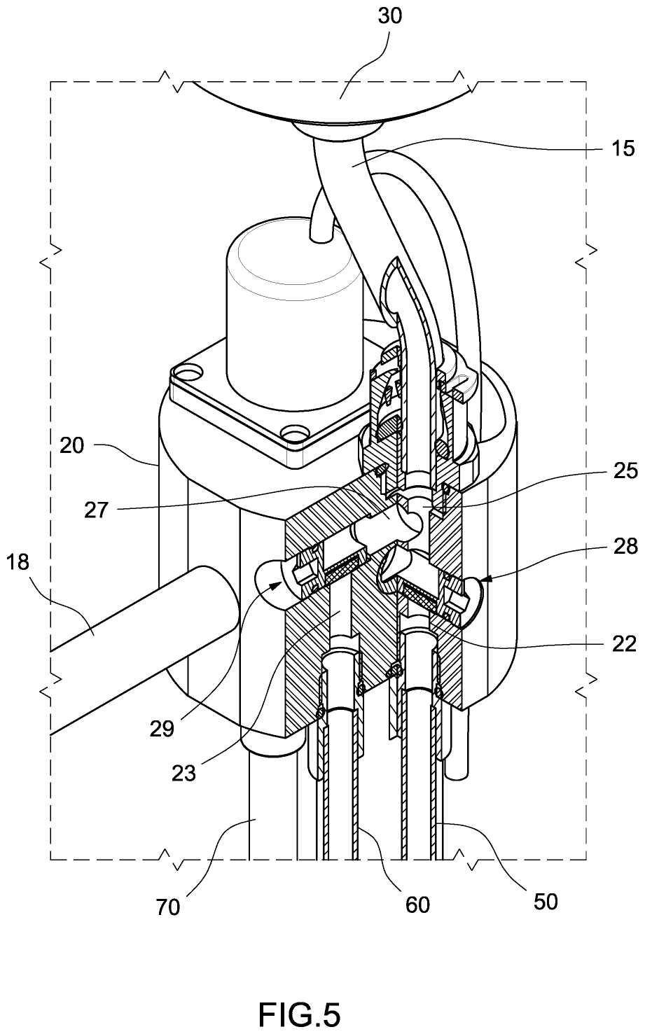

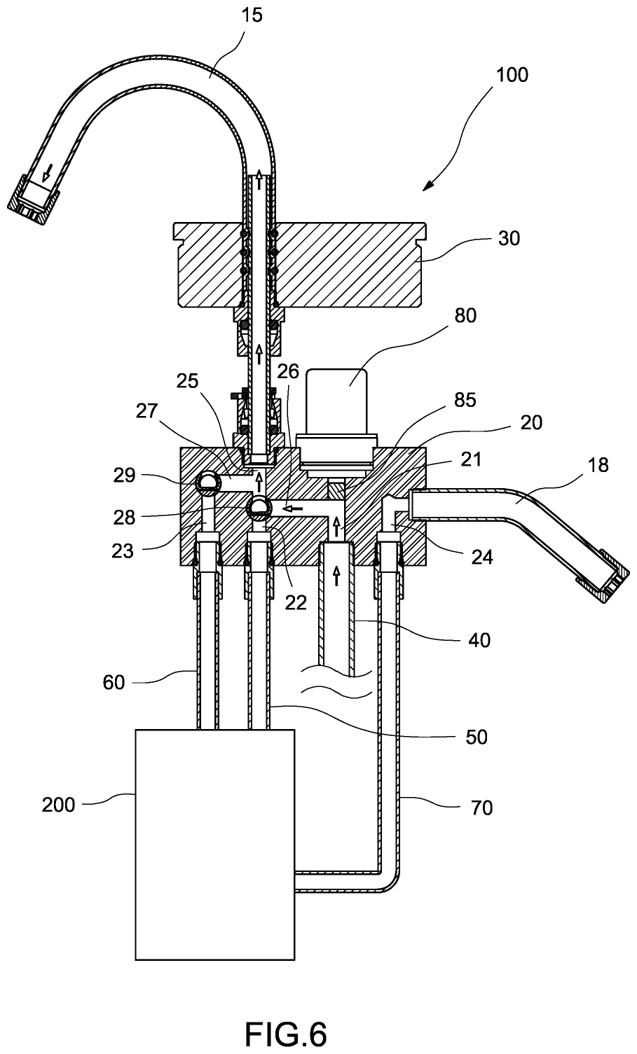

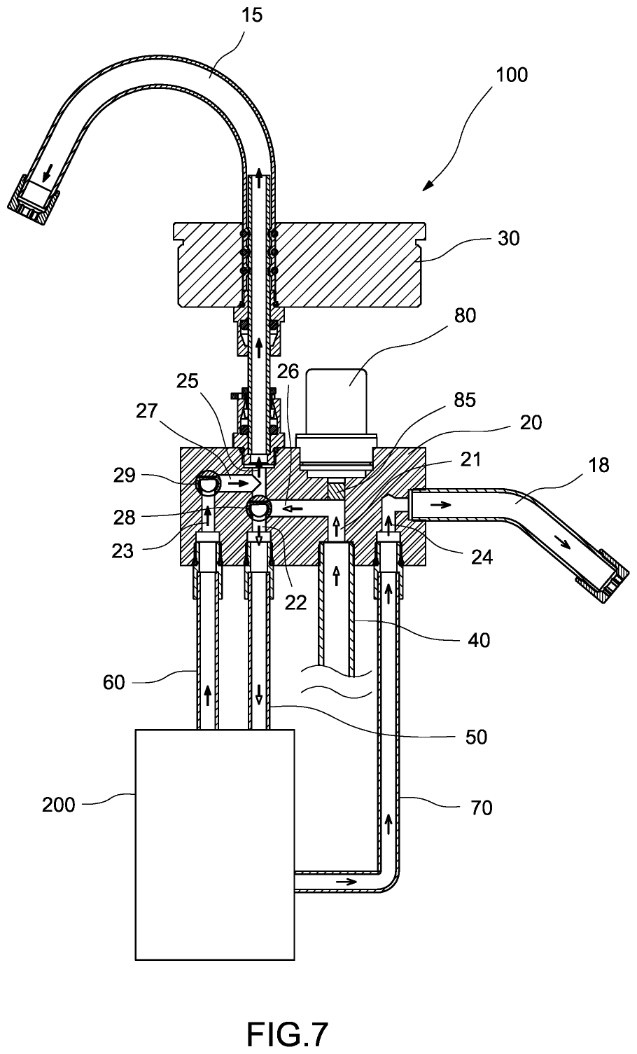

Referring to FIGS. 1 to 7, a faucet 100 in accordance with a first preferred embodiment of the invention is configured to connect to a water ionizer 200 and a tap water source 300 (or a water filter).

The faucet 100 comprises a housing 10, a mechanism 20 provided in the housing 10, a fastening member 30 secured to an upper portion of the housing 10 above the mechanism 20, a spout 15 extending from the mechanism 20 through the fastening member 30, and a selection switch 16 provided on an outer surface of the housing 10 for activating a flow from the water ionizer 200 or the tap water source 300. The selection switch 16 is a touch sensor switch, a toggle switch, or an infrared sensor switch.

The mechanism 20 is connected to the following: a first inlet line 40 connected to the tap water source 300, a second inlet line 50 connected to the water ionizer 200, and a guide line 60 connected to the water ionizer 200. The mechanism 20 includes a first inlet 21 connected to the first inlet line 40, a second inlet 22 connected to the second inlet line 50, a third inlet 23 connected to the guide line 60, an outlet 25 interconnecting the spout 15 and the second inlet 22, a first channel 26 connected to the first inlet 21, a first two-port valve 28 interconnecting the second inlet 22, the outlet 25, and the first channel 26 for permitting connection of the first channel 26 to the outlet 25 or connection of the first channel 26 to the second inlet 22, a second channel 27 interconnecting the outlet 25, the first two-port valve 28, and the third inlet 23, and a second two-port valve 29 interconnecting the second channel 27 and the third inlet 23 for shutting flow through the second channel 27 and the second inlet 23 or permitting flow through the second channel 27 and the second inlet 23. An electromagnetic valve 80 is provided on the mechanism 20, electrically connected to the selection switch 16, and controlled by the selection switch 16. The electromagnetic valve 80 includes a valve member 85 for opening or closing the first inlet 21.

A first drain 18 is extended out of the mechanism 20 and through the housing 10. A second drain 70 interconnects the mechanism 20 and the water ionizer 200. A third channel 24 interconnects the second drain 70 and the first drain 18 for flowing waste water from the water ionizer 200 to the first drain 18.

The first two-port valve 28 includes a body 281, a tunnel 282 through the body 281, a hole 283 communicating with the tunnel 281, and a sealing member 284 provided on an outer surface of the body 281. A tool (not numbered) may be inserted through the hole 283 to rotate the body 281. The second two-port valve 29 includes a body 291, a tunnel 292 through the body 291, a hole 293 communicating with the tunnel 291, and a sealing member 294 provided on an outer surface of the body 291. A tool (not numbered) may be inserted through the hole 293 to rotate the body 291. Initially, the first inlet line 40 is connected to the tap water source 300, the second inlet line 50 is connected to the water ionizer 200, the guide line 60 is connected to the water ionizer 200, and the second drain 70 is connected to the water ionizer 200.

In a first operation, a user may use a tool to turn the first two-port valve 28 to permit connection of the first channel 26 to the outlet 25 and disconnect the first channel 26 from the second inlet 22. Further, the user may use the tool to turn the second two-port valve 29 to disconnection the third inlet 23 from the second channel 27.

Prior to the first operation, the user may close the valve member 85 to shut the first inlet 21. In response to pressing the selection switch 16, the valve member 85 is opened to open the first inlet 21. Thus, water may flow from the first inlet line 40 to the spout 15 through the first inlet 21, the first channel 26, and the outlet 25. The provisions of the first two-port valve 28 and the second two-port valve 29 can prevent water from flowing back to the water ionizer 200 through the second inlet 22 or the third inlet 23. In a second operation, the user may use a tool to turn the first two-port valve 28 to permit connection of the first channel 26 to the second inlet 22 and disconnect the first channel 26 from the second inlet 22. Further, the user may use the tool to turn the second two-port valve 29 to disconnection the third inlet 23 from the outlet 25. Further, the user may use the tool to turn the second two-port valve 29 to permit connection of the third inlet 23 to the second channel 27.

Prior to the second operation, the user may close the valve member 85 to shut the first inlet 21. In response to pressing the selection switch 16, the valve member 85 is opened to open the first inlet 21. Thus, water may flow from the second inlet line 50 to the water ionizer 200 through the first inlet 21, the first channel 26, and the second inlet 22. The provision of the first two-port valve 28 can prevent water from exiting the spout 15 through the outlet 25.

Alkaline water generated by the water ionizer 200 may flow to the faucet 100 through the guide pipe 60. Further, the alkaline water flows to the spout 15 through the third inlet 23, the second channel 27, and the outlet 25. Waste water generated by the water ionizer 200 may flow to the first drain 18 through the second drain 70 and the third channel 24.

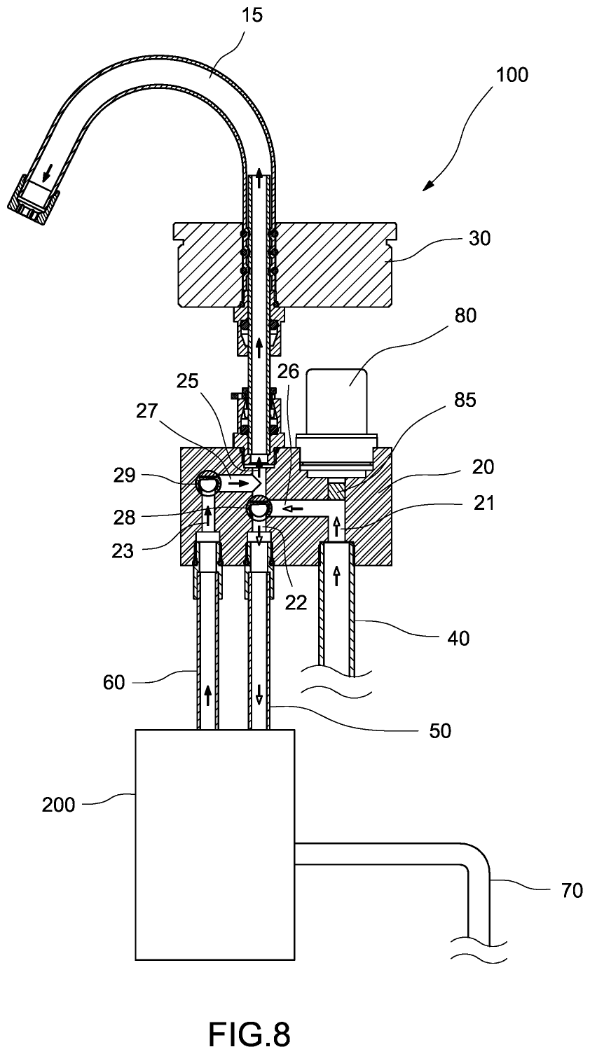

Referring to FIG. 8, a faucet in accordance with a second preferred embodiment of the invention is shown. The characteristics of the second preferred embodiment are substantially the same as that of the first preferred embodiment except the following: the water fed to the mechanism 20 is tap water or filtered water. For example, the faucet 100 is provided on a countertop of a kitchen. After installing the piping, tap water is fed to the first inlet line 40. And in turn, the water flows to the water ionizer 200 through the first inlet line 40, the first inlet 21, the first channel 26, the second inlet 22, and the second inlet line 50. The water ionizer 200 process the water, generates alkaline water and feeds the alkaline water to the spout 15 through the guide line 60, the third inlet 23, the second channel 27, and the outlet 25. Also, waste water flows from the water ionizer 200 to a sanitary sewer through the second drain 70.

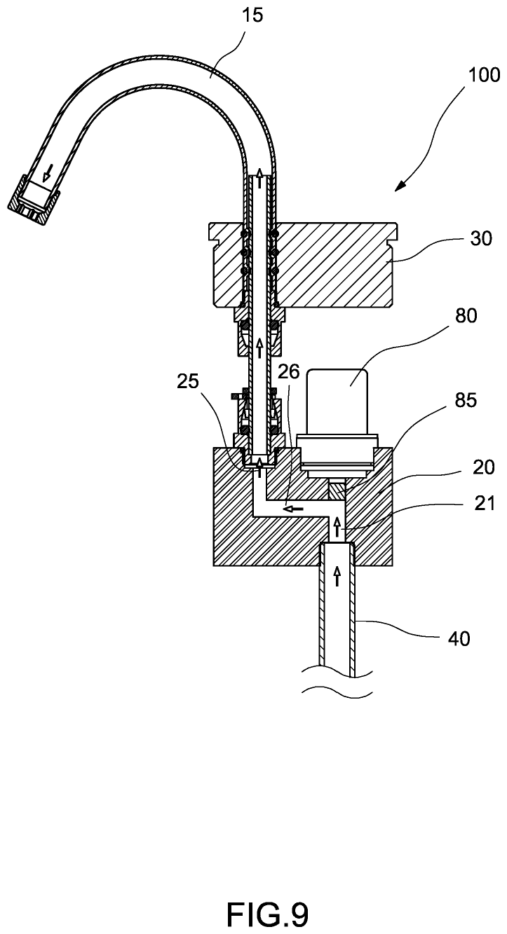

Referring to FIG. 9, a faucet in accordance with a third preferred embodiment of the invention is shown. The characteristics of the third preferred embodiment are substantially the same as that of the first preferred embodiment except the following: the water fed to the faucet 100 is tap water (or filtered water). For example, the faucet 100 is provided on a countertop of a kitchen. After installing the piping, tap water (or filtered water) is fed to the first inlet line 40. Finally, the water flows to the spout 15 through the first inlet 21 and the first channel 26.

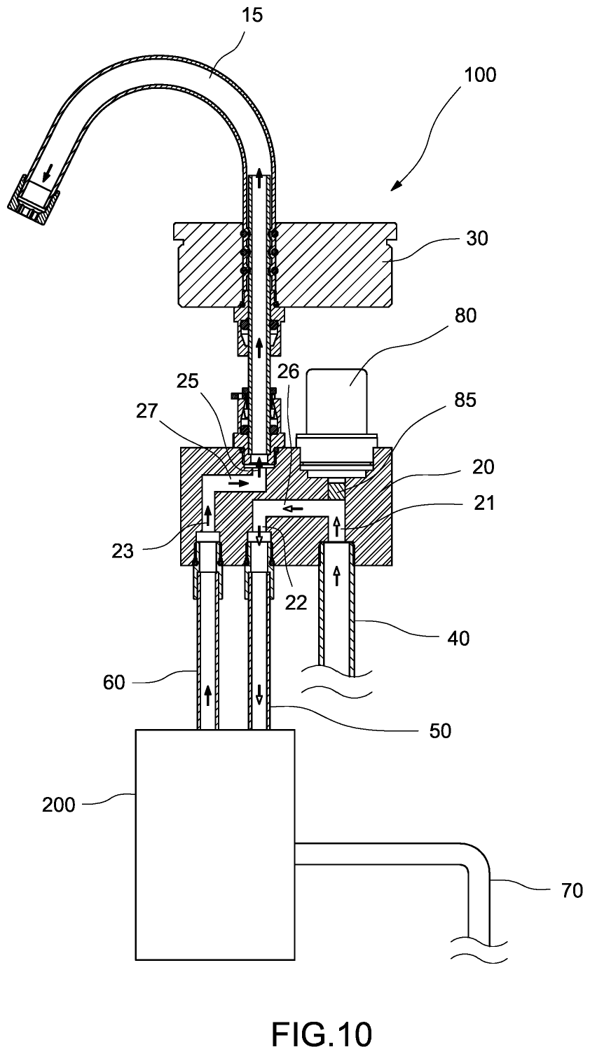

Referring to FIG. 10, a faucet in accordance with a fourth preferred embodiment of the invention is shown. The characteristics of the fourth preferred embodiment are substantially the same as that of the second preferred embodiment except the following: the first two-port valve 28 and the second two-port valve 29 are eliminated.

While the invention has been described in terms of preferred embodiments, those skilled in the art will recognize that the invention can be practiced with modifications within the spirit and scope of the appended claims.

What is claimed is:

1. A faucet for use with a water ionizer 200 and a tap water source 300, comprising a housing 10, a mechanism 20 disposed in the housing 10, a fastening member 30 secured to an upper portion of the housing 10 above the mechanism 20, a spout 15 extending from the mechanism 20 through the fastening member 30, and a selection switch 16 disposed on an outer surface of the housing 10 for activating a flow from the water ionizer 200 or the tap water source 300 wherein the mechanism 20 is connected to a first inlet line 40 connected to the tap water source 300, a second inlet line 50 connected to the water ionizer 200, and a guide line 60 connected to the water ionizer 200;
an electromagnetic valve 80 disposed on the mechanism 20, electrically connected to the selection switch 16, and controlled by the selection switch 16 wherein the electromagnetic valve 80 includes a valve member 85;
wherein the first inlet line 40 is connected to the tap water source 300, the second inlet line 50 is connected to the water ionizer 200, the guide line 60 is connected to the water ionizer 200, and the second drain 70 is connected to the water ionizer 200;
wherein in response to pressing the selection switch 16, the valve member 85 is opened to open or close the first inlet 21; and
wherein alkaline water generated by the water ionizer 200 is configured to flow to the spout 15 through the guide pipe 60, the third inlet 23, the second channel 27, and the outlet 25.

2. The faucet of claim 1, wherein the selection switch 16 is a touch sensor switch.

3. The faucet of claim 1, wherein the mechanism 20 includes a first inlet 21 connected to the first inlet line 40, a second inlet 22 connected to the second inlet line 50, a third inlet 23 connected to the guide line 60, an outlet 25 interconnecting the spout 15 and the second inlet 22, a first channel 26 connected to the first inlet 21, a first two-port valve 28 interconnecting the second inlet 22, the outlet 25, and the first channel 26 for permitting connection of the first channel 26 to the outlet 25 or connection of the first channel 26 to the second inlet 22, a second channel 27 interconnecting the outlet 25, the first two-port valve 28, and the third inlet 23, and a second two-port valve 29 interconnecting the second channel 27 and the third inlet 23 for shutting flow through the second channel 27 and the second inlet 23 or permitting flow through the second channel 27 and the second inlet 23.

4. The faucet of claim 1, further comprising a first drain 18 extending out of the mechanism 20 and through the housing 10; and a second drain 70 interconnecting the mechanism 20 and the water ionizer 200 wherein waste water generated by the water ionizer 200 is configured to flow to the first drain 18 through the second drain 70.

5. The faucet of claim 1, further comprising a first drain 18 extending out of the mechanism 20 and through the housing 10; a second drain 70 interconnecting the mechanism 20 and the water ionizer 200; and a third channel 24 interconnecting the second drain 70 and the first drain 18 for flowing waste water from the water ionizer 200 to the first drain 18 wherein waste water generated by the water ionizer 200 is configured to flow to the first drain 18 through the second drain 70 and the third channel 24.

6. The faucet of claim 1, wherein the first two-port valve 28 includes a first body 281, a first tunnel 282 through the first body 281, and a first hole 283 communicating with the first tunnel 281; and wherein the second two-port valve 29 includes a second body 291, a second tunnel 292 through the second body 291, and a second hole 293 communicating with the second tunnel 291.

7. The faucet of claim 1, wherein the first two-port valve 28 includes a first body 281, a first tunnel 282 through the first body 281, and a first hole 283 communicating with the first tunnel 281; and wherein the second two-port valve 29 includes a second body 291, a second tunnel 292 through the second body 291, and a second hole 293 communicating with the second tunnel 291.

8. The faucet of claim 1, wherein the first two-port valve 28 includes a first body 281, a first tunnel 282 through the first body 281, and a first hole 283 communicating with the first tunnel 281; and wherein the second two-port valve 29 includes a second body 291, a second tunnel 292 through the second body 291, and a second hole 293 communicating with the second tunnel 291.

9. The faucet of claim 1, wherein the first two-port valve 28 further comprises a first sealing member 284 disposed on an outer surface of the first body 281, and the second two-port valve 29 further comprises a second sealing member 284 disposed on an outer surface of the second body 291.

10. The faucet of claim 1, wherein the first two-port valve 28 further comprises a first sealing member 284 disposed on an outer surface of the first body 281, and the second two-port valve 29 further comprises a second sealing member 284 disposed on an outer surface of the second body 291.

11. The faucet of claim 1, wherein the first two-port valve 28 further comprises a first sealing member 284 disposed on an outer surface of the first body 281, and the second two-port valve 29 further comprises a second sealing member 284 disposed on an outer surface of the second body 291.

12. A faucet for use with a water ionizer 200 and a tap water source 300, comprising a housing 10, a mechanism 20 disposed in the housing 10, a fastening member 30 secured to an upper portion of the housing 10 above the mechanism 20, a spout 15 extending from the mechanism 20 through the fastening member 30, and a selection switch 16 disposed on an outer surface of the housing 10 for activating a flow from the water ionizer 200 or the tap water source 300 wherein the mechanism 20 is connected to a first inlet line 40 connected to the tap water source 300, and a second inlet line 50 connected to the water ionizer 200;
an electromagnetic valve 80 disposed on the mechanism 20, electrically connected to the selection switch 16, and controlled by the selection switch 16;
wherein the first inlet line 40 is connected to the tap water source 300, the second inlet line 50 is connected to the water ionizer 200, and the second drain 70 is connected to the water ionizer 200;
wherein in response to pressing the selection switch 16, the electromagnetic valve 80 is activated to open or close the first inlet 21; and
wherein alkaline water generated by the water ionizer 200 is configured to flow to the spout 15 through the third inlet 23, the second channel 27, and the outlet 25.

13. A faucet for use with a water ionizer 200 and a tap water source 300, comprising a housing 10, a mechanism 20 disposed in the housing 10, a fastening member 30 secured to an upper portion of the housing 10 above the mechanism 20, a spout 15 extending from the mechanism 20 through the fastening member 30, and a selection switch 16 disposed on an outer surface of the housing 10 for activating a flow from the water ionizer 200 or the tap water source 300 wherein the mechanism 20 is connected to a first inlet line 40 connected to the tap water source 300, a second inlet line 50 connected to the water ionizer 200, and a guide line 60 connected to the water ionizer 200;
an electromagnetic valve 80 disposed on the mechanism 20, electrically connected to the selection switch 16, and controlled by the selection switch 16;
wherein the first inlet line 40 is connected to the tap water source 300, the second inlet line 50 is connected to the water ionizer 200, the guide line 60 is connected to the water ionizer 200, and the second drain 70 is connected to the water ionizer 200;
wherein in response to pressing the selection switch 16, the electromagnetic valve 80 is activated to open or close the first inlet 21; and
wherein alkaline water generated by the water ionizer 200 is configured to flow to the spout 15 through the guide pipe 60, the third inlet 23, the second channel 27, and the outlet 25.
